(19) United States
(12) Patent Application Publication
(10) Pub. No.: US 2012/0140287 A1
(43) Pub. Date: Jun. 7, 2012

(54) PRINTING APPARATUS, DATA STORAGE METHOD, AND PROGRAM

(75) Inventor: Tadashi Kawaguchi, Tokyo (JP)

(73) Assignee: CANON KABUSHIKI KAISHA, Tokyo (JP)

(21) Appl. No.: 13/304,123

(22) Filed: Nov. 23, 2011

(30) Foreign Application Priority Data
Dec. 1, 2010 (JP) 2010-268622

(51) Int. Cl. G06K 15/00

(52) U.S. Cl. 358/1.16

(57) ABSTRACT

A printing apparatus having a reprint function includes a determination unit to determine whether newly input print data are able to be stored in an empty area of a data storage area, a selection unit to, if the determination unit determines that the newly input print data are not able to be stored in the empty area of the data storage area, select print data that matches a priority deletion condition from among print data pieces that have already been stored, a change unit to change, among deletion order information indicating a deletion order of the print data pieces stored in the data storage area, a deletion order corresponding to the print data selected by the selection unit, a deletion unit to delete corresponding print data based on the deletion order information, and a storage unit configured to store the newly input print data in the empty area.

### BACKGROUND OF THE INVENTION

1. Field of the Invention

Embodiments of the present invention relate to a printing apparatus, a data storage method, and a program.

2. Description of the Related Art

Recent single function printers (SFP) tend to use a secure digital (SD) card or a universal serial bus (USB) memory configured from a semiconductor storage element as a secondary storage device instead of a hard disk drive (HDD). Further, attempts are being made to make this storage capacity as small as possible and to reduce costs. On the other hand, as functions in a SFP, separate from the conventionally used BOX storage function, models are appearing that are newly provided with a reprint function. A “BOX storage function” is a function of storing print data for which an output instruction has been issued from a personal computer (PC) in a secondary storage device on the SFP side, and outputting the print data “at any time” based on a SFP operation. In contrast, unlike the BOX storage function, a reprint function does not guarantee the print data in the data storage area, and may only reprint the print data that may be stored in the data storage area.

In other words, in the BOX storage function, deletion of print data is only allowed based on a user request as a trigger. However, in the reprint function, based on the remaining capacity of the secondary storage device, old print data may be deleted without a user trigger if the newest print data are not able to be stored. More specifically, in the reprint function, based on the capacity of the data storage area in the secondary storage device, a limit is placed on the number of print data pieces that may be stored, so that the storage number rises and falls based on the size of the respective print data pieces.

In a conventional image forming apparatus provided with a reprint function, if print data having a large size is input at the timing when the area in the secondary storage device for storing print data, such as page description language (PDL) data and image data, has become low, the input operation into the image forming apparatus is stopped and the print data pieces are deleted from either the one having an older storage date and time, or the one that has already been printed (e.g., refer to Japanese Patent Application Laid-Open No. 11-355534).

However, considering the environment that SFPs are used in the recent office, cases in which a small number of SFPs are shared by a large number of users via a network may occur. In an office environment having a high network load, it is easy to think of a situation in which a large amount of print data is input into one SFP within a short period of time. In this case, despite the fact that a user has only input one piece of print data, depending on the subsequent print data input situation by other users and the size of the print data, there is an issue that even if the user tries to reprint the one piece of print data, the print data may not even be selected because the user's own data has already been deleted from the data storage area.

Further, according to the technique discussed in Japanese Patent Application Laid-Open No. 11-355534, when the data storage area has become full, print data is deleted from the one having an older storage date and time, so that the data storage area is cyclically used. Therefore, this technique does not overcome the above issue that occurs when executing reprint processing. Similarly, with the technique discussed in Japanese Patent Application Laid-Open No. 11-355534, when the data storage area has become full, print data is deleted from the one that has already been printed to control the reprinting of all of the print data pieces stored in the data storage area under equal conditions. Therefore, this technique also does not overcome the above issue that occurs when executing reprint processing.

### SUMMARY OF THE INVENTION

One disclosed aspect of the embodiments is directed to preventing as much as possible cases in which a user's own print data are not able to be selected when executing reprint processing, even when the capacity of a secondary storage device is low.

According to an aspect of the embodiments, a printing apparatus having a reprint function includes a determination unit configured to determine whether newly input print data are able to be stored in an empty area of a data storage area, a selection unit configured to, if it is determined by the determination unit that the newly input print data are not able to be stored in the empty area of the data storage area, select print data that matches a priority deletion condition from among print data pieces that have already been stored, a change unit configured to change, among deletion order information indicating a deletion order of the print data pieces stored in the data storage area, a deletion order corresponding to the print data selected by the selection unit, a deletion unit configured to delete corresponding print data based on the deletion order information, and a storage unit configured to store the newly input print data in the empty area of the data storage area.

According to the embodiments, cases in which a user's own print data are not able to be selected when executing reprint processing may be prevented as much as possible, even when the capacity of a secondary storage device is low.

Further features and aspects of the embodiments will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a hardware configuration of an image forming apparatus.

FIG. 2 illustrates an example of a configuration of a management table.

FIG. 3 illustrates an example of a state change in a deletion order storage queue.

FIG. 4 is a flowchart illustrating an example of a management control operation of a data storage area for PDL storage.

FIG. 5 is a flowchart illustrating an example of a management control operation of a data storage area for image data storage.

### DESCRIPTION OF THE EMBODIMENTS

Various exemplary embodiments, features, and aspects of the invention will be described in detail below with reference to the drawings. One disclosed feature of the embodiments may be described as a process which is usually depicted as a flowchart, a flow diagram, a timing diagram, a structure diagram, or a block diagram. Although a flowchart or a timing diagram may describe the operations or events as a sequential process, the operations may be performed, or the events may occur, in parallel or concurrently. In addition, the order of the operations or events may be re-arranged. A process is terminated when its operations are completed. A process may correspond to a method, a program, a procedure, a method of manufacturing or fabrication, a sequence of operations performed by an apparatus, a machine, or a logic circuit, etc.

An image forming apparatus according to a first exemplary embodiment is, for example, a common SFP that forms an image after receiving print data input from an external information device via an external interface (I/F), and outputs image data to a print engine (not illustrated). The image forming apparatus according to the first exemplary embodiment further includes a multifunction printer (MFP) that is connected to an image scanner (not illustrated) and added a function of performing image formation and image input/output operations based on an instruction from a display unit.

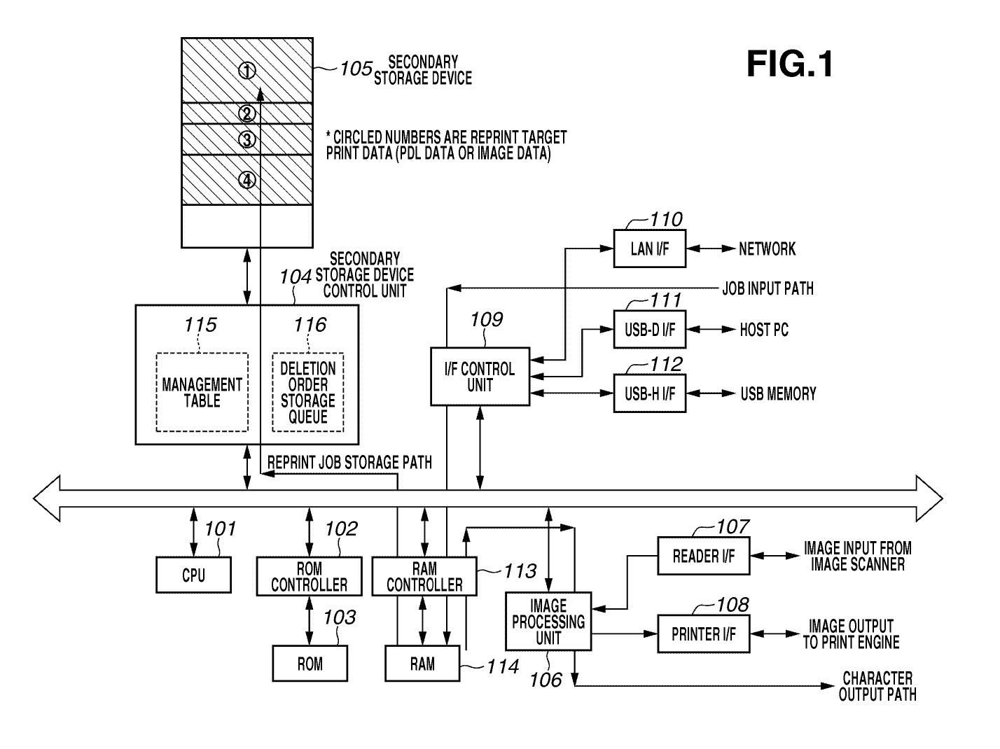

First, in FIG. 1, a central processing unit (CPU) 101 is a high-performance CPU that controls the entire image forming apparatus. The CPU 101 includes a large-scale integration (LSI) circuit that includes hardware circuits assembled by function block units in the same package. A read-only memory (ROM) controller 102 controls the reading and writing to/from a ROM 103. The ROM 103 is a non-volatile ROM that stores a boot program for activating an operating system (OS) of the image forming apparatus and programs for controlling the entire image forming apparatus.

A secondary storage device control unit 104 includes a management table 115 and a deletion order storage queue 116. The secondary storage device control unit 104 controls the reading and writing of data to/from a secondary storage device 105. The secondary storage device 105 includes a data storage area for storing PDL data, image data, and the like for a BOX storage function and a reprint function. The secondary storage device 105 is also used as an expansion buffer when transmitting and receiving data to/from an external information device.

An image processing unit 106 performs reader-type image processing on red-green-blue (RGB) digital image data output from a reader I/F 107, and print-type image processing on each yellow-magenta-cyan-black (YMCK) color component signal generated in the image forming apparatus. The reader I/F 107 handles the RGB digital image data between the image scanner (not illustrated) and the image processing unit 106. A printer I/F 108 handles YMCK output video data between the print engine (not illustrated) and the image processing unit 106.

An I/F control unit 109 transfers print data and image data between an external I/F, such as a local area network (LAN) I/F 110, a USB-device (USB-D) I/F 111, and a USB-host (USB-H) I/F 112, and a random access memory (RAM) 114. The LAN I/F 110 receives print data by performing communication control with an external information device via a network. The USB-D I/F 111 receives print data by performing communication control with an external information device via a USB. The USB-H I/F 112 controls, for example, a storage device into which a USB storage unit may be inserted, a card reader that enables charge control or section specification control, and an imaging apparatus.

A RAM controller 113 controls the reading and writing of data to/from the RAM 114. The RAM 114 functions as a main memory for the image forming apparatus. Further, the RAM 114 is a volatile RAM capable of high-speed reading and writing, which is also used as a work area for the image forming processing and a rasterization area for the image input/output processing.

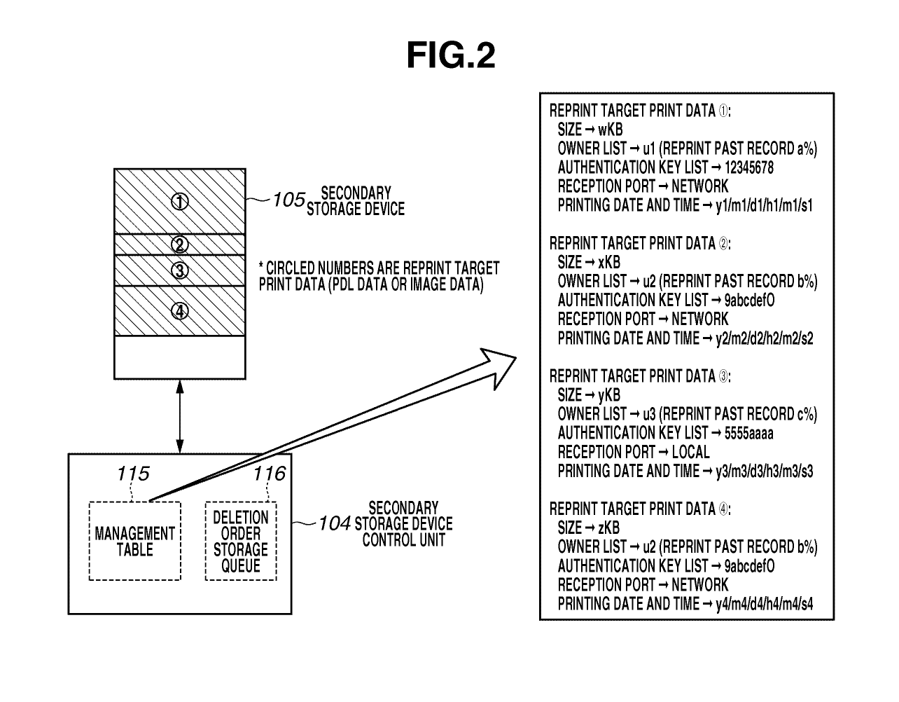

The management table 115 is included in the secondary storage device control unit 104. The management table 115 is a table storing, for example, size information, owner information, authentication information, reception port information, and printing date and time information of each piece of print data stored in the data storage area of the secondary storage device 105. Refer to FIG. 2 for the configuration of the management table 115 according to the present exemplary embodiment.

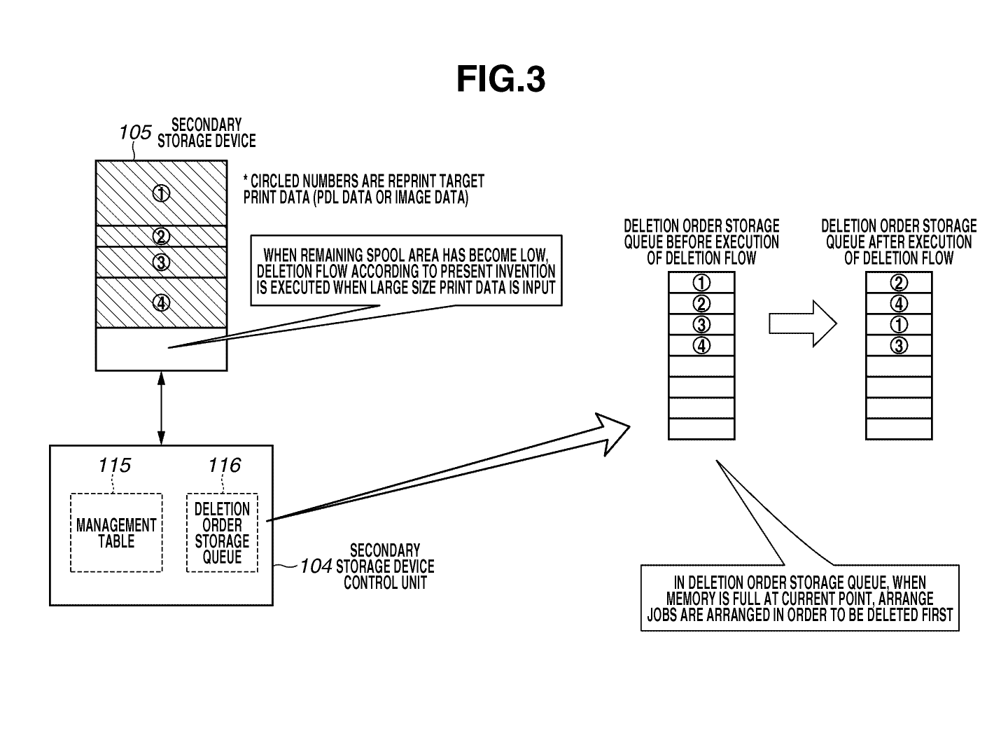

The deletion order storage queue 116 is included in the secondary storage device control unit 104. The deletion order storage queue 116 is a queue in which the deletion order of the print data pieces stored in the data storage area of the secondary storage device 105 is registered. The deletion order may be changed based on a change notification from the CPU 101. Refer to FIG. 3 regarding the configuration of the deletion order storage queue 116 according to the present exemplary embodiment and a state change when the deletion order is changed. The circled numbers and the order of those numbers in the deletion order storage queue 116 in the drawing are an example of deletion order information.

The processing performed in the following flowcharts is realized by the CPU 101 and/or the secondary storage device control unit 104 executing processing based on a program. Further, the image forming apparatus is an example of a printing apparatus (computer).

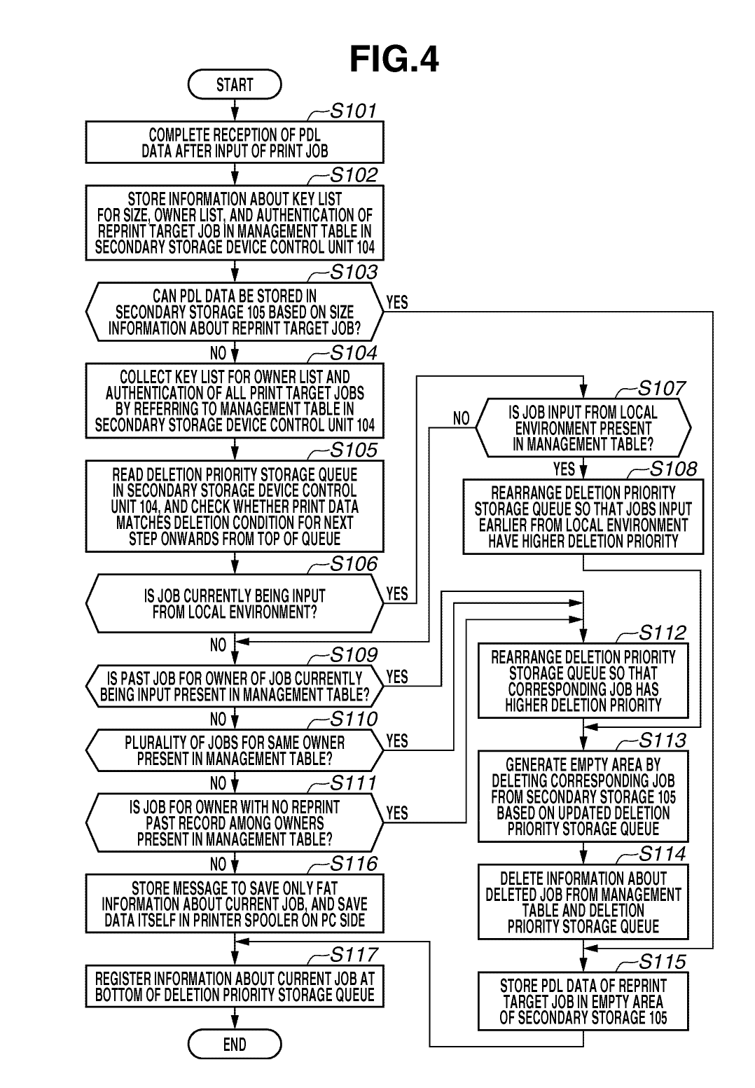

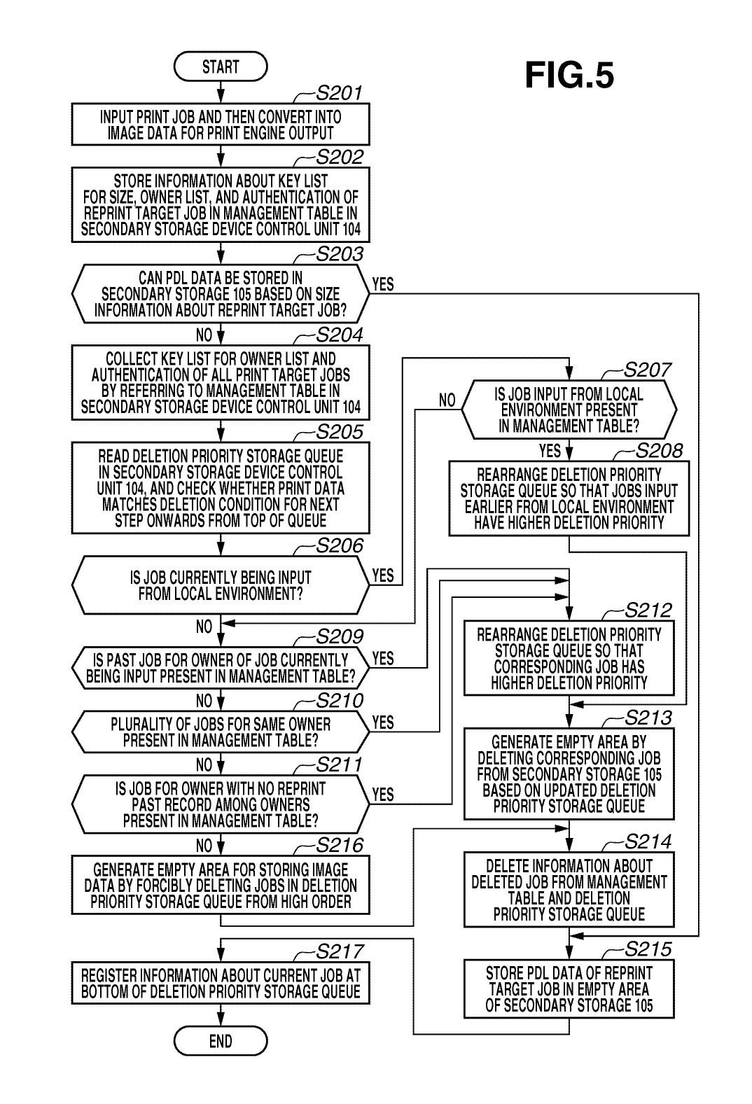

Next, operations performed in the present exemplary embodiment will be described using the flowcharts illustrated in FIGS. 4 and 5.

First, a case in which PDL data and a case in which image data serve as the print data stored in the data storage area of the secondary storage device 105 for a reprint function will be considered. Since each case has its advantages and disadvantages, examples will be described in which the data is stored in both formats. For PDL storage, management control of the data storage area is executed after the print data has been received (see FIG. 4). In contrast, for image data storage, management control of the data storage area is executed in parallel with the print processing operation (see FIG. 5).

Differences between PDL storage and image data storage include the following. First, since the size of the print data stored in the data storage area is smaller for PDL than for image data, PDL storage has the advantage that the number of print data pieces that may be stored is increased without largely occupying the data storage area capacity. Another difference is that when executing reprint processing, for PDL storage the print processing is executed by performing image processing again. In contrast, for image data storage, since image processing does not need to be performed again, there is the advantage that reprinting may be rapidly output.

Actual operations will now be described. FIG. 4 illustrates a case in which the print data stored in the data storage area is PDL data.

First, in operation S101, via the external I/F such as the LAN I/F 110 or the USB-D I/F 111, a print job is input from an external information device, and reception of the PDL data in the RAM 114 is completed. Then, in operation S102, the CPU 101 immediately stores PDL size information, job owner information, and authentication information for reprint execution corresponding to the newest print job in the management table 115. Obviously, the size information, owner information, and authentication information are already stored in the management table 115 for all the print data pieces that have been stored in the secondary storage device 105 at that point.

Next, the secondary storage device control unit 104 loads the sum of the PDL size information of the newest print job and the size information of the print data already stored in the secondary storage device 105 that are in the management table 115. Based on the sum, in operation S103, the secondary storage device control unit 104 calculates the empty area in the data storage area and determines whether the PDL data of the print job may be stored.

If it is determined that the PDL data of the print job may be stored (YES in operation S103), the processing proceeds to operation S115. In operation S115, the secondary storage device control unit 104 stores the PDL data corresponding to the newest print job stored in the RAM 114 in the empty area. Then, in operation S117, the secondary storage device control unit 104 registers the print job at the bottom of the deletion order storage queue 116.

If it is determined that the PDL data of the print job cannot be stored (NO in operation S103), the processing proceeds to operation S104. In operation S104, the secondary storage device control unit 104 collects from in the management table 115 all of the print data pieces already been stored in the secondary storage device 105 as well as the job owner information and the authentication information for reprint execution regarding the newest print job.

Next, in operation S105, the secondary storage device control unit 104 check whether there is print data matching a below-described condition that allows priority deletion from the top of the deletion order storage queue 116.

Initially, in operation S106, the secondary storage device control unit 104 determines whether the newest print job is a job that was input in a local environment.

“Local environment” refers to an environment in which printing is performed with the image forming apparatus directly connected to an external information device, and is based on the assumption that only one user may input print jobs into the image forming apparatus. In the present exemplary embodiment, the local environment corresponds to the case that the external information device (e.g., an information processing apparatus such as a PC) and the image forming apparatus are connected in a stand-alone manner via the USB-D 111.

In contrast, “network environment” refers to an environment in which a plurality of external information devices and the image forming apparatus are connected via a hub, a switch, a bridge, a router, or the like. For example, the network environment may be an environment such as a LAN or a wide area network (WAN), in which a plurality of users may input print jobs into the image forming apparatus. In the present exemplary embodiment, the network environment corresponds to the case that the external information devices and the image forming apparatus are connected to a local network environment via the LAN I/F 110.

When the newest print job is input from the local environment (YES in operation S106), the processing proceeds to operation S107. In operation S107, the secondary storage device control unit 104 searches for a reception port that is a local port from among the stored print data pieces based on the previously-collected information in the management table 115. This is because previously-stored local port print data has the same owner as the newest print job, so that the deletion priority of the previously-stored local port print data is increased when a plurality of files are stored.

If the search finds a match (YES in operation S107), the processing proceeds to operation S108. In operation S108, the secondary storage device control unit 104 changes the deletion order storage queue 116 so that the corresponding print data has a higher deletion priority. If there is a plurality of print data pieces, the secondary storage device control unit 104 changes the deletion order storage queue 116 so that the print data having the oldest date and time has a higher deletion priority. If the newest print job is input from the network environment (NO in operation S106), the secondary storage device control unit 104 advances the processing to operation S109.

In operation S109, the secondary storage device control unit 104 determines whether the owner information of the newest print job is included in the owner information of each print data stored in the management table 115. This is to increase the deletion priority if the same owner has input a plurality of files.

If there is a match between the owner information of the newest print job and the owner information of the respective print data pieces stored in the management table 115 (YES in operation S109), the processing proceeds to operation S112. In operation S112, the secondary storage device control unit 104 changes the deletion order storage queue 116 so that the corresponding print data has a higher deletion priority. If there is the plurality of print data pieces, the secondary storage device control unit 104 changes the deletion order storage queue 116 so that the print data having the oldest date and time has a higher deletion priority. If there is no match with the owner information of the newest print job (NO in operation S109), the secondary storage device control unit 104 advances the processing to operation S110.

In operation S110, the secondary storage device control unit 104 determines whether there is a plurality of print data pieces with the same owner in the owner information of each print data stored in the management table 115. Similar to operation S109, this is to increase the deletion priority if the same owner has input a plurality of files.

If there is the plurality of print data pieces with the same owner in the management table 115 (YES in operation S110), the processing proceeds to operation S112. In operation S112, the secondary storage device control unit 104 changes the deletion order storage queue 116 so that the print data having an older date and time has a higher deletion priority.

Then in operation S111, the secondary storage device control unit 104 confirms a reprint processing history that accompanies the owner information of each print data stored in the management table 115. For example, the secondary storage device control unit 104 calculates the ratio of print data that has undergone reprint processing with respect to the total number of print data pieces for each owner information, like the reprint past record illustrated in FIG. 2, and determines whether the calculated ratio value is equal to or less than a predetermined threshold. This is to increase the deletion priority by determining that owners having the calculated value equal to or less than the predetermined threshold do not use the reprint function as much as other owners.

If there is print data of the owner having the calculated value equal to or less than the threshold among the print data pieces stored in the management table 115 (YES in operation S111), the processing proceeds to operation S112. In operation S112, the secondary storage device control unit 104 changes the deletion order storage queue 116 so that the corresponding print data has a higher deletion priority. If there is a plurality of print data pieces, the secondary storage device control unit 104 changes the deletion order storage queue 116 so that the print data having the oldest date and time has a higher deletion priority.

In operation S113, based on the deletion order storage queue 116 changed in operation S108 or operation S112, the secondary storage device control unit 104 deletes the corresponding print data in the secondary storage device 105 to generate an empty area for storing the newest print job PDL data.

In operation S114, the secondary storage device control unit 104 deletes the print data in the secondary storage device 105, then deletes the information corresponding to the deleted print data from the management table 115 and the deletion order storage queue 116. The deletion in this disclosure means not only clearing existing bits entirely to make the portion reusable so that to make a space including an empty area but also just releasing portions of storage storing information to make the portion reusable without clearing existing bits to make a space including an empty area.

In operation S115, the secondary storage device control unit 104 stores the PDL data corresponding to the newest print job stored in the RAM 114 in the empty area of the secondary storage device 105 generated in operation S113. Then, in operation S117, the secondary storage device control unit 104 registers the print job at the bottom of the deletion order storage queue 116.

If the operation in each of operations S106, S107, S109, S110, and S111 was a “NO”, the secondary storage device control unit 104 cannot newly generate the empty area for the newest print job in the secondary storage device 105. Consequently, in operation S116, the secondary storage device control unit 104 manages so that only file allocation table (FAT) information about the newly-input print job is stored in the management table 115, thereby allowing the newly-input print job to be differentiated from the other print data. Further, the secondary storage device control unit 104 transmits a notification to the external information device to retain that an entity of the PDL data that should be stored in the division setting 205 on the external information device side, such as on the host computer.

During PDL storage, after reception of the print data is completed, the secondary storage device 105 according to the present exemplary embodiment executes management control. Consequently, when the external information device receives the above notification, the PDL data in the print spooler is retained. If the notification does not reach the external information device within a predetermined time, a printer driver controls so that the PDL data in the print spooler is deleted.

Then, after the processing in operation S116 is executed too, in operation S117, the secondary storage device control unit 104 registers the print job at the bottom of the deletion order storage queue 116.

Thus, according to the present exemplary embodiment, when PDL data is stored in the data storage area of the secondary storage device 105, the deletion order of the deletion order storage queue 116 is changed so that management control of the data storage area is optimally performed. Therefore, the present exemplary embodiment may produce an effect that since the area for storage of the newest print data may be constantly and optimally generated, cases in which a user's own print data cannot be selected when executing reprint processing may be prevented as much as possible.

In the present exemplary embodiment, the deletion priority regarding a plurality of local port print data pieces is increased. However, a constraint may be applied when the print data is stored into the secondary storage device 105. More specifically, when a plurality of print data pieces is input from a local port, even if there is an empty area in the secondary storage device 105, the deletion order storage queue 116 may be changed by deleting old local port print data so that new local port print data is stored.

Similarly, although in the present exemplary embodiment, the deletion priority is increased when the owner information about the newest print job matches owner information in the management table 115, a constraint may be applied when the print data is stored into the secondary storage device 105. More specifically, when the owner information about the newest print job matches the owner information in the management table 115, even if there is an empty area in the secondary storage device 105, the old print data in the management table 115 for that owner is deleted. Then, the deletion order storage queue 116 may be changed so that new print data for the owner is stored.

Consequently, in addition to changing the deletion priority, by applying the constraint during storage into the secondary storage device 105, an effect may be produced that cases in which a user's own print data cannot be selected when executing reprint processing may be prevented as much as possible, even if the capacity of the secondary storage device is low.

Next, as a second exemplary embodiment, a case in which the print data stored in the data storage area is image data will be described with reference to FIG. 5.

First, via the external I/F such as the LAN I/F 110 or the USB-D I/F 111, a print job is input from the external information device, and reception of the image data in the RAM 114 is completed. Then, the image data is converted into a raster pattern by a rendering control unit (not illustrated), and a video signal is generated via the image processing unit 106 and the printer I/F 108 for output to the print engine. In the present exemplary embodiment, the image data that is converted to the raster pattern is stored in the secondary storage device 105 for reprint control from the RAM 114. Further, the same effect may be produced when the format of the stored image data is a RGB data format or a YMCK data format.

In operation S201, the image data to be stored in the RAM 114 is generated. Then, in operation S202, the CPU 101 stores image data size information, job owner information, and authentication information for reprint execution corresponding to the newest print job in the management table 115. Obviously, the above-described information is already stored in the management table 115 for all the print data pieces that have been stored in the secondary storage device 105 at that point.

The operations from operation S203 onwards are generally similar to those performed during PDL storage. The difference is that if all of the operations in operations S206, S207, S209, S210, and S211 are a “NO”, then in operation S216, the secondary storage device control unit 104 forcibly deletes the print data from the top of the deletion order storage queue 116 for image data storage and generates an empty area in the secondary storage device 105.

Similar to PDL data storage, this is performed because if the print spooler configuration is changed so as to store the image data in the memory on the external information device side, the image data largely occupies the amount of used memory on the external information device side, and the time taken to release the print spooler increases. Therefore, during image data storage, the image forming apparatus does not issue a notification to the external information device to store the image data.

Thus, according to the present exemplary embodiment, when image data is stored in a data storage area of the secondary storage device 105, the deletion order of the deletion order storage queue 116 is changed so that management control of the data storage area is optimally performed. Therefore, the present exemplary embodiment may produce an effect that since the area for storage of the newest print data may be constantly and optimally generated, cases in which a user's own print data cannot be selected when executing reprint processing may be prevented as much as possible.

Further, similar to the first exemplary embodiment, in addition to changing the deletion priority of the deletion order storage queue 116, a constraint is applied during storage into the secondary storage device 105. Consequently, an effect may be produced that cases in which a user's own print data cannot be selected when executing reprint processing may be prevented as much as possible, even if the capacity of the secondary storage device is low.

According to the first and second exemplary embodiments, the image forming apparatus takes the initiative and fixes the format of the print data to be stored in the data storage area of the secondary storage device 105 for the reprint function at a PDL data format or an image data format. In contrast, in a third exemplary embodiment, the print data format is specified by the initiative of the external information device, not by the image forming apparatus. Consequently, in the present exemplary embodiment, PDL data and image data are stored in a mixed manner in the data storage area of the secondary storage device 105 in the image forming apparatus.

The operation flowcharts according to the present exemplary embodiment are as illustrated in FIGS. 4 and 5. When a print job is input from the external information device, the CPU 101 may determine the format of the print data to be stored in the secondary storage device 105. Consequently, for PDL data storage, the CPU 101 performs the operations as illustrated in the flowchart of FIG. 4, and for image data storage, performs the operations as illustrated in the flowchart of FIG. 5.

Thus, according to the present exemplary embodiment, the external information device is in control of specifying the format for the print data stored in the data storage area of the secondary storage device 105. Consequently, the deletion order of the deletion order storage queue 116 is changed so that management control of the data storage area is optimally performed for when the print data format is either PDL data or image data, respectively. Therefore, similar to the first and second exemplary embodiments, the third exemplary embodiment may produce an effect that since the area for storage of the newest print data may be constantly and optimally generated, cases in which a user's own print data cannot be selected when executing reprint processing may be prevented as much as possible.

According to each of the above exemplary embodiments, cases in which a user's own print data cannot be selected when executing reprint processing may be prevented as much as possible, even when the capacity of a secondary storage device is low.

Aspects of the embodiments may also be realized by a computer of a system or apparatus (or devices such as a CPU or MPU) that reads out and executes a program recorded on a memory device to perform the functions of the above-described embodiment(s), and by a method, the operations of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

Further, the present exemplary embodiment may also be realized by supplying software (e.g., a program or a set of instructions) for realizing the functions of the above exemplary embodiments to a system or an apparatus via a network or via various storage media, and having a computer (a central processing unit (CPU) or a micro processing unit (MPU)) of the system or apparatus read and execute the program or the instructions recorded/stored on an article of manufacture having a memory device or a non-transitory storage medium to perform operations or functions of the above-described embodiments. In this case, this program and the recording/storage medium on which the program is recorded/stored constitute one disclosed aspect of the embodiments. In addition, the program may be executed by one computer, or by a plurality of computers linked together.

Disclosed aspects of the embodiments may be realized by an apparatus, a machine, a method, a process, or an article of manufacture that includes a non-transitory storage medium having a program or instructions that, when executed by a machine or a processor, cause the machine or processor to perform operations as described above. The method may be a computerized method to perform the operations with the use of a computer, a machine, a processor, or a programmable device. The operations in the method involve physical objects or entities representing a machine or a particular apparatus (e.g., a printing apparatus, a data storage area). In addition, the operations in the method transform the elements or parts from one state to another state. The transformation is particularized and focused on storing data. The transformation provides a different function or use such as determining if newly input print data are able to be stored, selecting print data, changing a deletion order, etc.

In addition, elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any optical, electromechanical, electromagnetic, or electronic devices. The term software generally refers to a logical structure, a method, a procedure, a program, a routine, a process, an algorithm, a formula, a function, an expression, etc. A software implementation typically includes realizing the above elements (e.g., logical structure, method, procedure, program) as instruction codes and/or data elements embedded in one or more storage devices and executable and/or accessible by a processor, a CPU/MPU, or a programmable device as discussed above. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations.

All or part of an embodiment may be implemented by various means depending on applications according to particular features, functions. These means may include hardware, software, or firmware, or any combination thereof. A hardware, software, or firmware element may have several modules or units coupled to one another. A hardware module/unit is coupled to another module/unit by mechanical, electrical, optical, electromagnetic or any physical connections. A software module/unit is coupled to another module by a function, procedure, method, subprogram, or subroutine call, a jump, a link, a parameter, variable, and argument passing, a function return, etc. A software module/unit is coupled to another module/unit to receive variables, parameters, arguments, pointers, etc. and/or to generate or pass results, updated variables, pointers, etc. A firmware module/unit is coupled to another module/unit by any combination of hardware and software coupling methods above. A hardware, software, or firmware module/unit may be coupled to any one of another hardware, software, or firmware module/unit. A module/unit may also be a software driver or interface to interact with the operating system running on the platform. A module/unit may also be a hardware driver to configure, set up, initialize, send and receive data to and from a hardware device. An apparatus may include any combination of hardware, software, and firmware modules/units.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-268622 filed Dec. 1, 2010, which is hereby incorporated by reference herein in its entirety.

What is claimed is:

1. A printing apparatus having a reprint function, comprising:
a determination unit configured to determine whether newly input print data are able to be stored in an empty area of a data storage area;
a selection unit configured to, if it is determined by the determination unit that the newly input print data are not able to be stored in the empty area of the data storage area, select print data that matches a priority deletion condition from among print data pieces that have already been stored;
a change unit configured to change, among deletion order information indicating a deletion order of the print data pieces stored in the data storage area, a deletion order corresponding to the print data selected by the selection unit;
a deletion unit configured to delete corresponding print data based on the deletion order information; and
a storage unit configured to store the newly input print data in the empty area of the data storage area.

2. The printing apparatus according to claim 1, wherein the selection unit is configured to switch the priority deletion condition based on whether the newly input print data is print data input from a local environment or print data input from a network environment.

3. The printing apparatus according to claim 1, wherein the selection unit is configured to switch the priority deletion condition if owner information about the newly input print data is in owner information of a plurality of print data pieces stored in the data storage area.

4. The printing apparatus according to claim 3, wherein the selection unit is configured to switch the priority deletion condition if there is a plurality of owner information pieces about the newly input print data in the owner information of the plurality of print data pieces stored in the data storage area.

5. The printing apparatus according to claim 1, wherein the selection unit is configured to switch the priority deletion condition based on whether reprint processing that is managed for each piece of the owner information in the print data has been performed.

6. The printing apparatus according to claim 1, further comprising a notification unit configured to, if print data that matches the priority deletion condition are not able to be selected by the selection unit, issue a message to store only file allocation table (FAT) information about the print data and retain an entity of the print data to be stored in the data storage area in an information processing apparatus.

7. A method for storing data executed by a printing apparatus having a reprint function, the method comprising:
determining whether newly input print data are able to be stored in an empty area of a data storage area;
selecting, if it is determined that the newly input print data are not able to be stored in the empty area of the data storage area, print data that matches a priority deletion condition from among print data pieces that have already been stored;
changing, among deletion order information indicating a deletion order of the print data pieces stored in the data storage area, a deletion order corresponding to the selected print data;
deleting corresponding print data based on the deletion order information; and
storing the newly input print data in the empty area of the data storage area.

8. A computer-readable storage medium having a program that, when executed by a computer, causes the computer to perform operations comprising:
determining whether newly input print data are able to be stored in an empty area of a data storage area;
selecting, if it is determined that the newly input print data are not able to be stored in the empty area of the data storage area, print data that matches a priority deletion condition from among print data pieces that have already been stored;
changing, among deletion order information indicating a deletion order of the print data pieces stored in the data storage area, a deletion order corresponding to the selected print data;
deleting corresponding print data based on the deletion order information; and
storing the newly input print data in the empty area of the data storage area.
